(19) United States
(12) Patent Application Publication
(10) Pub. No.: US 2025/0247755 A1
(43) Pub. Date: Jul. 31, 2025

(54) MANAGING INTEROPERABILITY OF NG-RAN NODES IN UE HANDOVER

(71) Applicant: RAKUTEN SYSMPHONY, INC., Tokyo (JP)

(72) Inventor: Subramanya CHANDRASHEKAR, Karnataka (IN)

(73) Assignee: RAKUTEN SYSMPHONY, INC., Tokyo (JP)

(21) Appl. No.: 18/694,187

(22) PCT Filed: Jan. 25, 2024
(86) PCT No.: PCT/US2024/012856

§ 371 Date: Mar. 21, 2024

(30) Foreign Application Priority Data
Apr. 3, 2023 (IN) 202341025338
Nov. 30, 2023 (IN) 202341025338

(51) Int. Cl. H04W 36/08; H04W 36/00

(52) U.S. Cl. CPC H04W 36/08; H04W 36/0085

(57) ABSTRACT

Embodiments of the present disclosure discloses managing interoperability of NG-RAN nodes in UE handover. The method comprises transmitting an Xn handover request to handover a UE from the source NG-RAN node (204) to a target NG-RAN node (206) including a list of AI/ML use cases configured at the source NG-RAN node (204). Further, a Xn handover response is received from the target NG-RAN node. Further, the method comprises determining, measurement reconfiguration data (319) for the UE by the source NG-RAN node based on the active list of AI/ML use cases until the UE is handed over to the target NG-RAN node. Thereafter, the method comprises transmitting, an RRC reconfiguration message, comprising the measurement reconfiguration data, to the UE (202), for dynamically updating the list of AI/ML use cases. The present disclosure may reduce unnecessary overhead for the NG-RAN nodes by eliminating reception of measurements from the UE.

### CROSS-REFERENCE TO RELATED APPLICATION

This application claims priority from Indian Provisional Application No. 202341025338 filed on Apr. 3, 2023, and Indian Application No. 202341025338 filed on Nov. 30, 2023, the disclosures of which are incorporated herein by reference in their entirety.

### TECHNICAL FIELD

The present disclosure generally relates to managing interoperability of NG-RAN nodes in UE handover.

### BACKGROUND

3rd Generation Partnership Project (3GPP) release 18 specification includes use of Artificial Intelligence/Machine Learning (AI/ML) models for optimizing Radio Access Network (RAN) and air interfaces. The AI/ML models focus on improving energy consumption, signal support, and user behavior prediction. Due to the complexity of networks, 3GPP release 18 focuses on establishing a framework by specifying data collection enhancements and signal support for the AI/ML-based energy saving, load balancing, mobility management, channel state information feedback, beam management, and position accuracy cases.

The AI/ML model generation requires a lot of data which is sourced from an entity in the network or from a User Equipment (UE). With every 3GPP release there may be new AI/ML use cases that may be released which may or may not require involvement of UE. For instance, consider if training the AI/ML models of such new AI/ML use cases require involvement of the UE performed at the network, it is imperative that the measurements at the UE or some assistance information from the UE may be required at the network periodically or based on an occurrence of an event. As the AI/ML models are data driven, measurements at the UE or assistance information from the UE form a critical part of the AI/ML model generation in the AI/ML use cases requiring involvement of UEs.

When the UE undergoes mobility between base stations, a combination of the scenarios is possible with respect to the mobility as follows:
a. Source and target Next Generation (NG)-RAN nodes belong to a same vendor and are interoperable with each other.
b. The source and target NG-RAN nodes belong to the same vendor and non-interoperable due to different software releases in use.
c. The source and target NG-RAN nodes belong to different vendors and still interoperable for example two NG-RAN nodes supplied by different ORAN vendors.
d. The source and target NG-RAN nodes belong to different vendors and non-interoperable due to the different AI/ML models supported by them or one of the NG-RAN nodes not supporting the AI-ML use-case in question.

Based on the aforementioned scenarios, various instances such as, but not limited to, interoperability, partial interoperability or non-interoperability may occur between a source NG-RAN node and a target NG-RAN node as the AI/ML use cases, their corresponding AI/ML models and the corresponding measurements supported by each NG-RAN node such as the source NG-RAN node and the target NG-RAN node may be different. Furthermore, since these AI/ML models are applicable to a number of UEs, a lot of unnecessary overhead occurs due to vast amounts of data sent over an air interface because of the partial interoperability or the non-interoperability between the NG-RAN nodes.

Hence, there is a need for an improvised interoperability management of NG-RAN nodes in UE handover.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The AI/ML model generation requires a lot of data which is sourced from an entity in the network or from a User Equipment (UE). With each 3GPP release there may be new use cases that may be released which may or may not require involvement of UE. Based on the aforementioned scenarios, various instances such as, but not limited to, interoperability, partial interoperability or non-interoperability may occur between a source NG-RAN node and a target NG-RAN node as the AI/ML use cases, their corresponding AI/ML models and the corresponding measurements supported by each NG-RAN node such as the source NG-RAN node and the target NG-RAN node may be different. Furthermore, since these AI/ML models are applicable to a number of UEs, a lot of unnecessary overhead occurs due to vast amounts of data sent over the air interface because of partial interoperability or non-interoperability between the NG-RAN nodes.

In an embodiment, managing interoperability of NG-RAN nodes in UE handover is disclosed. The source NG-RAN node transmits over an inter NG-RAN node interface to a target NG-RAN node, an Xn handover request to handover a User Equipment (UE) from the source NG-RAN node to the target NG-RAN node. The Xn handover request comprises a list of Artificial Intelligence or Machine Learning (AI/ML) use cases configured at the source NG-RAN node for the UE and a corresponding first measurement information associated with the list of AI/ML use cases. In response to the Xn handover request, the source NG-RAN node receives from the target NG-RAN node, a Xn handover response comprising an active list of AI/ML use cases to be configured for the UE at the target NG-RAN node and a corresponding second measurement information associated with the active list of AI/ML use cases, based on the list of AI/ML use cases received by the target NG-RAN node from the source NG-RAN node. Furthermore, the source NG-RAN node determines measurement reconfiguration data for the UE, based on the active list of AI/ML use cases received from the target NG-RAN node, until the UE is handed over to the target NG-RAN node. Thereafter, the source NG-RAN node transmits in a Radio Resource Control (RRC) reconfiguration message, the measurement reconfiguration data, to the UE, for dynamically updating measurements according to the list of AI/ML use cases supported by the target NG-RAN node for the UE, based on the measurement reconfiguration data.

In another embodiment, a method for a source Next Generation-Radio Access Network (NG-RAN) node. The method comprises transmitting, by the source NG-RAN node, an Xn handover request to handover a User Equipment (UE) from the source NG-RAN node to a target NG-RAN node. The Xn handover request comprises a list of Artificial Intelligence or Machine Learning (AI/ML) use cases configured at the source NG-RAN node for the UE and a corresponding first measurement information associated with the list of AI/ML use cases. In response to the Xn handover request, the method comprises receiving, by the source NG-RAN node from the target NG-RAN node, a Xn handover response comprising an active list of AI/ML use cases to be configured for the UE at the target NG-RAN node and a corresponding second measurement information associated with the active list of AI/ML use cases, based on the list of AI/ML use cases transmitted to the target NG-RAN node from the source NG-RAN node. Further, the method comprises determining, by the source NG-RAN node, measurement reconfiguration data for the UE based on the active list of AI/ML use cases received from the target NG-RAN node, until the UE is handed over to the target NG-RAN node. Thereafter, the method comprises transmitting, by the source NG-RAN node, a Radio Resource Control (RRC) reconfiguration message, comprising the measurement reconfiguration data, to the UE, for dynamically updating measurements according to the list of AI/ML use cases supported by the target NG-RAN node for the UE, based on the measurement reconfiguration data.

In yet another embodiment, a non-transitory computer readable medium including instructions stored thereon that when processed by at least one processor, cause a source NG-RAN node to perform operations comprising transmitting over an inter NG-RAN node interface to a target NG-RAN node to a target NG-RAN node, by source NG-RAN node an Xn handover request to handover a User Equipment (UE) from the source NG-RAN node to the target NG-RAN node. The Xn handover request comprises a list of Artificial Intelligence or Machine Learning (AI/ML) use cases configured at the source NG-RAN node for the UE and a corresponding first measurement information associated with the list of AI/ML use cases. Furthermore, the instructions cause the source NG-RAN node to perform the operations comprising receiving from the target NG-RAN node, a Xn handover response comprising an active list of AI/ML use cases to be configured for the UE at the target NG-RAN node and a corresponding second measurement information associated with the active list of AI/ML use cases, based on the list of AI/ML use cases received by the target NG-RAN node from the source NG-RAN node in response to the Xn handover request. Furthermore, the instructions cause the source NG-RAN node to perform the operations comprising determining reconfiguration measurement data for the UE, based on the active list of AI/ML use cases received from the target NG-RAN node, until the UE is handed over to the target NG-RAN node. Thereafter, the instructions cause the source NG-RAN node to perform the operations comprising transmitting in a Radio Resource Control (RRC) reconfiguration message, the measurement reconfiguration data, to the UE, for dynamically updating measurements according to the list of AI/ML use cases supported by the target NG-RAN node for the UE, based on the measurement reconfiguration data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an overview of communication between different base stations through Xn interface during handover, in accordance with an exemplary problem scenario:

FIG. 2A illustrates an Xn setup procedure with an exemplary scenario, in accordance with some embodiments of the present disclosure:

FIG. 2B shows an exemplary system for managing interoperability of NG-RAN nodes in UE handover, in accordance with some embodiments of the present disclosure:

FIG. 3 shows a detailed block diagram of a source NG-RAN node, in accordance with some embodiments of the present disclosure:

FIG. 4 shows a sequence diagram depicting an exemplary embodiment for managing interoperability of NG-RAN nodes in UE handover, in accordance with some embodiments of the present disclosure; and

FIG. 5 shows a flowchart illustrating a method for a source NG-RAN node, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

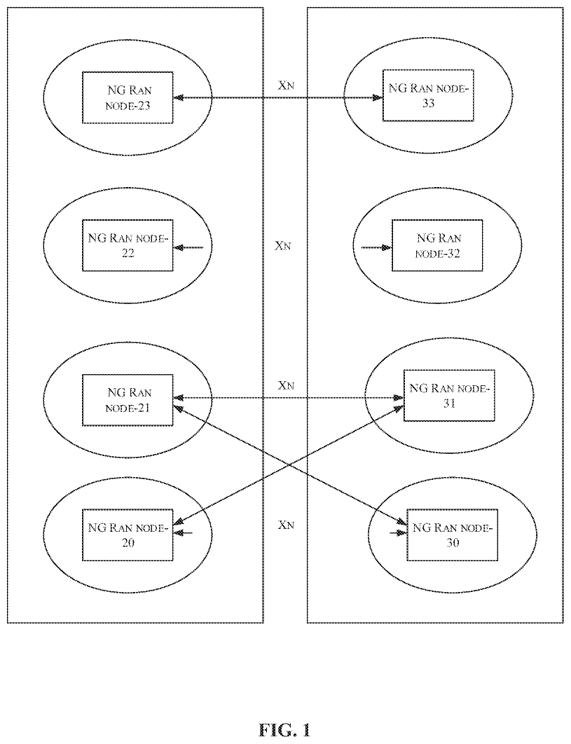

When the UE undergoes mobility between base stations, a combination of the scenarios is possible with respect to mobility. Because of the combination of scenarios, various instances such as, but not limited to, interoperability, partial interoperability or non-interoperability may occur between a source NG-RAN node and a target NG-RAN node. An exemplary scenario of partial interoperability between the NG-RAN nodes is shown in FIG. 1.

FIG. 1 shows an overview of communication between different base stations through Xn interface during handover, in accordance with an exemplary problem scenario. In some instances, NG-RAN node 20, NG-RAN node 21, NG-RAN node 22, NG-RAN node 23 may belong to one vendor and NG-RAN node 30, NG-RAN node 31, NG-RAN node 32, NG-RAN node 33 may belong to another vendor. There may be instances where some nodes may be interoperable, and some nodes may be non-interoperable. Based on the aforementioned instance, when the UE moves from the NG-RAN node 23 to NG-RAN node 31 which is partially interoperable for one of the sub-set of AI/ML use cases, there may be non-relevant measurements along with relevant measurements between the serving NG-RAN node and the target NG-RAN due to the partial interoperability between the NG-RAN node 23 and the NG-RAN node 31.

It shall be noted that, for convenience of explanation the disclosure uses terms and names defined in 3GPP RAN. More specifically, the terms Radio Access Network (RAN), Radio Resource Configuration (RRC), User Equipment (UE), Artificial Intelligence (AI) or Machine Learning (ML) mode, Next Generation Radio Access Network (NG-RAN), Key Performance Indicators (KPIs) and the like are to be interpreted as specified by the 3GPP RAN standards.

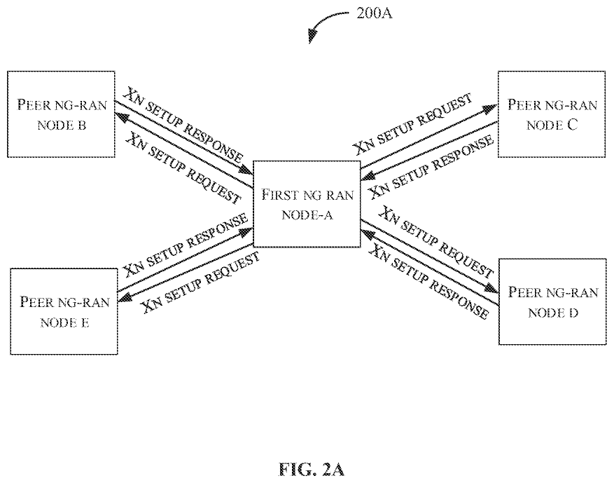

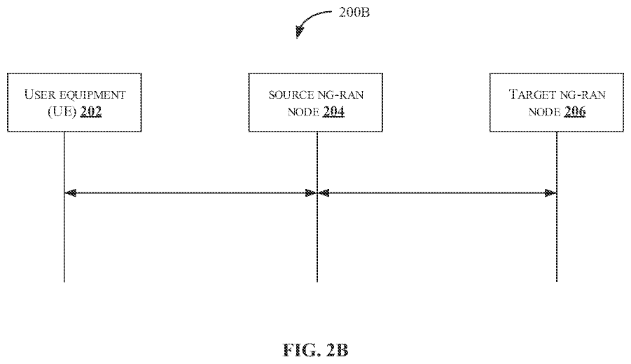

FIG. 2A illustrates an Xn setup procedure with an exemplary scenario, in accordance with some embodiments of the present disclosure.

In some embodiments, prior to handovers, an Xn Setup procedure is performed between NG-RAN nodes for exchanging configuration data required for the NG-RAN nodes to interoperate correctly over an Xn-C interface. The Xn setup procedure is explained with the help of an exemplary scenario in FIG. 2A. In the FIG. 2A, there is a first NG-RAN node A and peer NG-RAN nodes B, C, D and E. The Xn Setup procedure may be initiated between the first NG-RAN node A and each of the peer NG-RAN nodes B, C, D and E, by sending an Xn setup request by either of the communicating NG-RAN nodes. In the exemplary scenario, it is considered that the first NG-RAN node A is sending the Xn setup requests to each of the peer NG-RAN nodes B, C, D and E. The Xn setup request of the first NG-RAN node may include information indicating a list of AI/ML use cases supported by the first NG-RAN node, and interoperability information of AI/ML models of the AI/ML use cases supported by the first NG-RAN node. In some embodiments, the interoperability information may indicate for instance, versions of the AI/ML models that are interoperable, vendor software implemented for the AI/ML models that are interoperable and the like. In response to the Xn setup request. each of the peer NG-RAN nodes B, C, D and E may send Xn setup response to the first NG-RAN node. The Xn setup response may include information indicating a list of AI/ML use cases supported by the corresponding peer NG-RAN node, and interoperability information of AI/ML models of the AI/ML use cases supported by the corresponding peer NG-RAN node. In some embodiments, the interoperability between any two NG-RAN nodes may be an operator configured parameter. In some embodiments, information exchanged between the NG-RAN nodes through the Xn setup procedure enables the first NG-RAN node A and the peer NG-RAN nodes B, C, D and E to filter only interoperable peer NG-RAN nodes for future actions such as handover of a UE. For instance, consider based on the information exchanged between the first NG-RAN node A and the peer NG-RAN nodes B, C, D and E during the Xn setup procedure, the first NG-RAN node A identifies that it is not interoperable with peer NG-RAN nodes C and E. Therefore, when a UE needs to be handed over from the first NG-RAN node A, the peer NG-RAN nodes C and E may not be considered as eligible target NG-RAN nodes for handing over the UE, due to non-interoperability inferred during the Xn setup procedure.

FIG. 2B shows a system (200B) for managing interoperability of NG-RAN nodes in UE (202) handover, in accordance with some embodiments of the present disclosure.

The system (200B) may be a telecommunication network including a UE (202), a source NG-RAN node (204) and a target NG-RAN node (206). In some other embodiments, the system (200B) may be a radio access network. In some embodiments, the source NG-RAN node (204) is the NG-RAN node which is currently serving the UE (202), and the target NG-RAN node (206) is the NG-RAN node selected for handing over the UE (202) from the source NG-RAN node (204) upon occurrence of a handover scenario.

In some embodiments, the source NG-RAN node (204) may send a Xn handover request to the target NG-RAN node (206) to handover the UE (202) from the source NG-RAN node (204) to the target NG-RAN node (206). The Xn handover request may include a list of AI/ML use cases configured at the source NG-RAN node (204) for the UE (202) and a corresponding first measurement information associated with the list of AI/ML use cases. In some embodiments, the first measurement information includes measurement parameters of the UE (202) associated with the list of AI/ML use cases configured at the source NG-RAN node (204). For example, if the AI/ML use case is cell deformation for beam management, then the first measurement information may include, for instance, requirement of 30 Mbps bandwidth, 4 lambda wavelength, and the like. In some embodiments, based on the interoperability of the target NG-RAN node (206), the Xn handover request may also include Key Performance Indicators (KPIs) associated with each AI/ML use case to ensure better Quality of Service (QOS) for the UE (202). In response to the handover request, in some embodiments, the target NG-RAN node (206) may send a Xn handover response to the source NG-RAN node (204). The Xn handover response may include an active list of AI/ML use cases to be configured in the UE (202) and a corresponding second measurement information associated with the active list of AI/ML use cases. The active list of AI/ML use cases may include a list of AI/ML use cases to be de-configured or configured from the list of AI/ML use cases received by the target NG-RAN node (206) from the source NG-RAN node (204). This active list of AI/ML use cases are the use cases supported by the target NG-RAN node (206). The active list of AI/ML use cases may be selected by the target NG-RAN node (206) based on factors such as version of the AI/ML models, capability to support certain AI/ML use cases, and the like.

In some embodiments, based on the active list of AI/ML use cases received from the target NG-RAN node (206), the source NG-RAN node (204) may determine a measurement reconfiguration data for the UE (202) until the UE (202) is handed over to the target NG-RAN node (206). The measurement reconfiguration data may include a set of AI/ML measurements for the use cases to be de-configured by identifying the AI/ML use cases other than the one or more AI/ML use cases selected by the target NG-RAN node (206). The measurement reconfiguration data may further include a set of additional measurements for the new AI/ML use cases to be configured at the target NG-RAN node (206) for the UE (202). In some embodiments, a check on whether the additional set of measurements are supported by the UE (202) may be performed by the target NG-RAN node (206) based on a capability of the UE (202) shared by the source NG-RAN node (204) to the target NG-RAN node (206) through the Xn handover request.

In some embodiments, the source NG-RAN node (204) may transmit the measurement reconfiguration data to the UE (202) via an RRC reconfiguration message. The measurement reconfiguration data may be updated dynamically by the UE (202) according to the list of AI/ML use cases supported by the target NG-RAN node (206) for the UE (202). In some embodiments, the source NG-RAN node (204) may transmit the RRC reconfiguration message along with the Handover (HO) command or separately. In some embodiments, based on the measurement reconfiguration data, the UE (202) may dynamically update measurements according to the list of AI/ML use cases supported by the target NG-RAN node (206) for the UE (202). Thereafter, the UE (202) may send an uplink synchronization request to the target NG-RAN node (206) via a Random Access Channel (RACH) preamble. In response to the uplink synchronization request, a random access response may be sent to the target NG-RAN node (206) for establishing a connection between the target NG-RAN node (206) and the UE (202). In some embodiments, upon establishing connection between the UE (202) and the target NG-RAN node (206), the UE (202) may be configured to share a measurement report based on the updated measurement reconfiguration data for the set of AI/ML use cases via a RRC message to the target NG-RAN node (206).

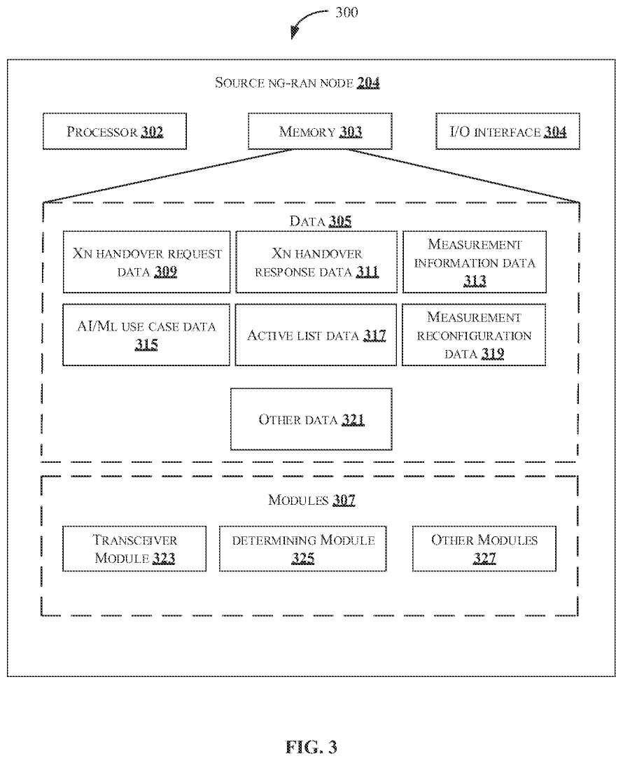

FIG. 3 shows a detailed block diagram of a source NG-RAN node (204), in accordance with some embodiments of the present disclosure.

In some implementations, the source NG-RAN node (204) may include an I/O interface (304), a processor (302) and a memory (303). In an embodiment, the memory (303) may be communicatively coupled to the processor (302) of the source NG-RAN node (204). The processor (302) may be configured to perform one or more functions of the source NG-RAN node (204) for managing interoperability of NG-RAN nodes in UE (202) handover, using data (305) and one or more modules (307). In an embodiment, the memory (303) may store data (305) of the source NG-RAN node (204). Although the FIG. 3 shows the hardware components of the source NG-RAN node (204), it is to be understood that other embodiments are not limited thereon. In other embodiments, the source NG-RAN node (204) may include less or a greater number of components. Further, the labels or names of the components are used only for illustrative purpose and does not limit the scope. One or more components can be combined together to perform the same or substantially similar technical feature for the managing interoperability of NG-RAN nodes in UE (202) handover.

In an embodiment, the data (305) stored in the memory (303) may include, without limitation, Xn handover request data (309), Xn handover response data (311), measurement information data (313), AI/ML use case data (315), active list data (317), measurement reconfiguration data (319) and other data (321). In some implementations, the data (305) may be stored within the memory (303) in the form of various data structures. Additionally, the data (305) may be organized using data models, such as relational or hierarchical data models. The other data (321) may include various temporary data and files generated by the one or more modules (307).

In an embodiment, the Xn handover request data (309) comprises an Xn handover request that is sent by a source NG-RAN node (204) to a target NG-RAN node (206) along with the list of AI/ML use cases for managing interoperability of NG-RAN nodes in UE (202) handover. The Xn handover request data (309) may include, but not limited to, a list of AI/ML use cases configured at the source NG-RAN node (204) for the UE (202) and a corresponding first measurement information associated with the list of AI/ML use cases.

In an embodiment, the Xn handover response data (311) comprises an Xn handover response received from the target NG-RAN node (206) comprising an active list of AI/ML use cases to be configured in the UE (202) and a corresponding second measurement information associated with the active list of AI/ML use cases, based on the list of AI/ML use cases.

In some embodiments, the measurement information data (313) may include measurements required from the UE (202) for implementing AI/ML use cases configured at the NG-RAN node such as the source NG-RAN node (204) or the target NG-RAN node (206). In the context of the present disclosure, the measurement information data (313) may include a first measurement information and a second measurement information. The first measurement information comprises measurement parameters of the UE (202) associated with the list of AI/ML use cases that may be configured at the source NG-RAN node (204) for the UE (202). The second measurement information comprises measurement parameters of the UE (202) associated with the active list of AI/ML use cases configured at the target NG-RAN node (206) for the UE (202) during a handover of the UE (202) from the source NG-RAN (204) to the target NG-RAN (206).

In an embodiment, the AI/ML use case data (315) may include the list of AI/ML use cases configured at the source NG-RAN node (204) for the UE (202). For example, the list of AI/ML use cases may include, but not limited to, beam management and load management for network energy saving, selection of UE (202). For instance, consider the AI/ML use case to be beam management. The first measurement information for the beam management may include required bandwidth, throughput, latency for performing cell deformation as a part of the beam management for direct transmission or reception of cells.

In an embodiment, the active list data (317) may include the active list of AI/ML use cases determined at the target NG-RAN node (206) for the UE (202) based on the list of AI/ML use cases configured at the source NG-RAN node (204) for the UE (202). The active list of AI/ML use cases may be the AI/ML use cases supported by the target NG-RAN (206). The active list of AI/ML use cases may include at least one of, but not limited to, the one or more AI/ML use cases selected by the target NG-RAN node (206) from the list of AI/ML use cases received from the source NG-RAN node (204) and one or more additional AI/ML use cases needed by the target NG-RAN node (206). For example, the one or more AI/ML use cases selected by the target NG-RAN node (206) based on the aforementioned example as per paragraph includes load management for network energy saving in the active list of AI/ML use cases to be configured for the UE (202), as the target NG-RAN node (206) supports the load management use case.

In an embodiment, the measurement reconfiguration data (319) may include measurements that may be configured or de-configured based on the active list of use-cases. The measurements for the set of AI/ML use cases may be de-configured by identifying the AI/ML use cases other than the one or more AI/ML use cases selected by the target NG-RAN node (206) from the list of AI/ML use cases configured at the source NG-RAN node (204). The measurement reconfiguration data (319) may also include the set of additional measurements for the new AI/ML use cases to be configured at the target NG-RAN node (206) for the UE (202). For example, if the selected AI/ML use cases by the target NG-RAN node (206) requires measurements such as X, Y and Z for the use case “beam management”. Consider the earlier measurements configured for the UE (202) for the use case “beam management” was X. P, Q, and R. Therefore, to comply with the selected AI/ML use cases of the target NG-RAN node (206), the UE (202) may be required to de-configure the measurements P, Q and R, and configure measurements Y and Z instead. This data related to de-configuring and configuring which is determined by the source NG-RAN node (204) and transmitted to the UE (202) may be referred as the measurement reconfiguration data (319).

In an embodiment, the data (305) may be processed by the one or more modules (307). In some implementations, the one or more modules (307) may be communicatively coupled to the processor (302) for performing one or more functions of the source NG-RAN node (204). In an implementation, the one or more modules (307) may include, without limiting to, a transceiver module (323), a determining module (325), and other modules (327).

As used herein, the term module may refer to a hardware processor (302) (shared, dedicated, or group) and memory that execute one or more software or firmware programs, a combinational logic circuit, and/or other suitable components that provide the described functionality. In an implementation, each of the one or more modules (307) may be configured as stand-alone hardware computing units. In an embodiment, the other modules (327) may be used to perform various miscellaneous functionalities on the source NG-RAN node (204). It will be appreciated that such one or more modules (307) may be represented as a single module or a combination of different modules.

In an embodiment, the transceiver module (323) may be configured to transmit the Xn handover request over an inter NG-RAN node interface to a target NG-RAN node (206) to handover the UE (202) from the source NG-RAN node (204) to the target NG-RAN node (206). In some embodiments, the Xn handover request may include, but not limited to, a list of AI/ML use cases configured at the source NG-RAN node (204) for the UE (202) and a corresponding first measurement information associated with the list of AI/ML use cases.

In response to the Xn handover request, the transceiver module (323) may be configured to receive the Xn handover response from the target NG-RAN node (206). In some embodiments, the Xn handover response may include, but not limited to, an active list of AI/ML use cases to be configured for the UE (202) at the target NG-RAN node (206) and a corresponding second measurement information associated with the active list of AI/ML use cases, based on the list of AI/ML use cases transmitted to the target NG-RAN node (206) by the source NG-RAN node (204).

Based on the active list of AI/ML use cases received from the target NG-RAN node (206) in the handover response, the determining module (325) may be configured to determine the measurement reconfiguration data (319) until the UE (202) is handed over to the target NG-RAN node (206). In some embodiments, determining the measurement reconfiguration data (319) comprises determining measurements that may be configured or de-configured based on the active list of use-cases. In some embodiments, the determining module (325) may determine a set of measurements for AI/ML use cases configured at the source NG-RAN node (204) for the UE (202), to be de-configured. In some other embodiments, the determining module (325) may determine a set of additional measurements for the new AI/ML use cases to be configured in the UE (202).

In an embodiment, the transceiver module (323) may be configured to transmit the measurement reconfiguration data (319) to the UE (202) in the form of an RRC reconfiguration message. However, the transmission of the measurement reconfiguration data (319) using the RRC reconfiguration message need not be construed as a limitation as the measurement reconfiguration data (319) may be transmitted using other message types that are capable of supporting similar functionality as the RRC reconfiguration message.

In some embodiments, upon receiving the measurements reconfiguration data (319), the UE (202) may dynamically update the measurements according to the list of AI/ML use cases supported by the target NG-RAN node (206).

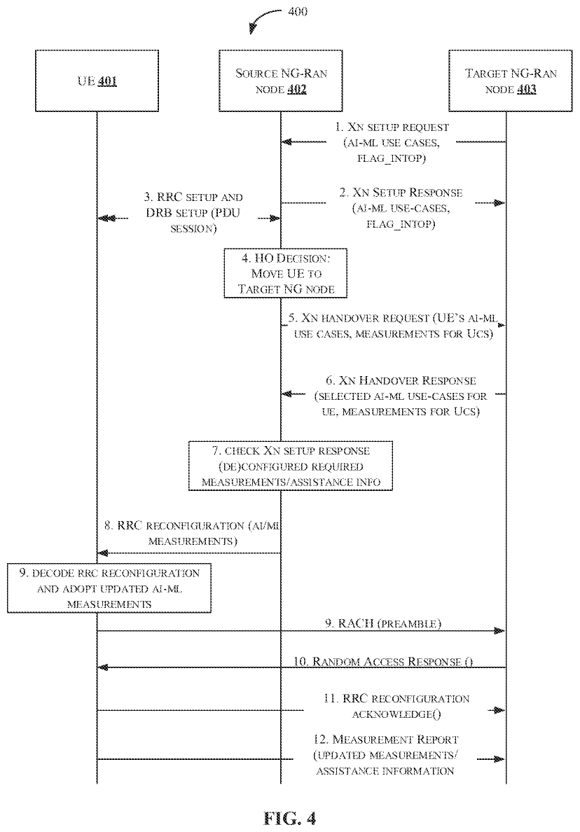

FIG. 4 shows a sequence diagram depicting an exemplary embodiment for managing interoperability of NG-RAN nodes in UE (401) handover, in accordance with some embodiments of the present disclosure.

At step 1, a target NG-RAN (403) node may send a Xn setup request indicating to handover the UE (401) from the source NG-RAN node (402) to the target NG-RAN node (403). At step two, the source NG-RAN node (402) may send an Xn setup response including an information indicating a list of supported AI/ML use cases that includes information on if a particular AI/ML model is interoperable with the target NG-RAN node (403). At step three, a connection is established between the source NG-RAN node (402) and the UE (401) based on a Radio Resource Control (RRC) setup and a Data Radio Bearer (DRB) setup, such that the UE (401) is served by the source NG-RAN node (402). At step 4, a handover decision is made, wherein the UE (401) is decided to be handed over to the target NG-RAN node (403).

At step five, the source NG-RAN node (402) may send a Xn handover request to handover the UE (401) from the source NG-RAN node (402) to the target NG-RAN node (403). The Xn handover request may include a list of AI/ML use cases configured at the source NG-RAN node (402) for the UE (401) and a corresponding first measurement information associated with the list of AI/ML use cases. In response to the handover request, at step six, the target NG-RAN node (403) may send a Xn handover response to the source NG-RAN node (402). The handover response may include an active list of AI/ML use cases to be configured in the UE (401) and a corresponding second measurement information associated with the active list of AI/ML use cases. The active list of AI/ML use cases is based on the list of AI/ML use cases received by the target NG-RAN node (403) from the source NG-RAN node (402).

Based on the active list of AI/ML use cases received from the target NG-RAN node (403), at step seven, the source NG-RAN node (402) may determine a measurement reconfiguration data (319) for the UE (401) until the UE (401) is handed over to the target NG-RAN node (403). The measurement reconfiguration data (319) may include a set of AI/ML measurements for the use case to be de-configured and a set of additional measurements for the new AI/ML use cases to be configured at the target NG-RAN node (403) for the UE (401).

At step eight, the source NG-RAN node (402) may transmit the measurement reconfiguration data (319) to the UE (401) via an RRC reconfiguration message. This measurement reconfiguration data (319) may be updated dynamically by the UE (401) according to the list of AI/ML use cases supported by the target NG-RAN node (403) for the UE (401). Based on the measurement reconfiguration data (319), at step nine, the UE (401) may update the measurement reconfiguration data (319) for the respective AI/ML use cases and may send an uplink synchronization request with the target NG-RAN node (403) via a RACH preamble. In response to the uplink synchronization request, at step ten, a random access response may be sent to the target NG-RAN node (403) for establishing a connection between the target NG-RAN node (403) and the UE (401). At step eleven, a connection may be established between the target NG-RAN node (403) and the UE (401) based on the RRC reconfiguration acknowledgment shared from the UE (401) to the target NG-RAN node (403). Upon establishing connection between the UE (401) and the target NG-RAN node (403), at step twelve, the UE (401) may share a measurement report based on the updated measurement reconfiguration data (319) for the set of AI/ML use cases via a RRC message to the target NG-RAN node (403).

Henceforth, the process of managing interoperability of NG-RAN nodes in UE (202) handover is explained with the help of one or more use case examples for better understanding of the present disclosure. However, the one or more examples should not be considered as limitation of the present disclosure.

In an exemplary scenario one, managing interoperability of NG-RAN nodes in UE (202) handover based on a use case 1 is shown below.

In the exemplary scenario 1, consider a beam management use case that performs cell de-formation to predict an appropriate beam for the UE (202). Consider a total of 10 beams are created at a network node 1 and a network node 2. Based on the total number of beams, consider a source NG-RAN node (204) predicts that beam 5 at time TI is the appropriate beam in the spatial domain for the UE (202) and the relevant measurement information 1 for retaining only beam 5 at time TI using load of 5 packets with 30 Mbps bandwidth. At step 1, the source NG-RAN node (204) shares an Xn handover request including the beam management use case along with the measurement information 1. However, consider a scenario where, the target NG-RAN node (206) considers that beam 5 and beam 4 at time TI are the appropriate beams in the spatial domain for the UE (202) and the measurement information 2 for the beam management use case is that, beam 5 and beam 4 at time TI being the appropriate beams require 7 packets of load with 20 Mbps bandwidth. At step two, the target NG-RAN node (206) shares the measurement information 2 along with the beam management use case to the source NG-RAN node (204). Based on the measurement information 2, the source NG-RAN node (204) determines measurement reconfiguration data for the UE (202) which means, the configuration at the UE (202) needs to be updated to 7 packets from 5 packets of load, 30 Mbps to 20 Mbps so that only beam 4 and beam 5 among 10 beams can be retained at time TI for the UE (202). This updated measurement reconfiguration data is shared to the UE (202). Based on the updated measurement reconfiguration data, the UE (202) shares a measurement report to the target NG-RAN node (206) for the beam management use case.

In an exemplary scenario two illustrates managing interoperability of NG-RAN nodes in UE (202) handover based on a use case 2.

In the exemplary scenario two, consider the load balancing use case for network energy saving for the UE (202) is performed. The source NG-RAN node (204) determines that for half an hour after 12 hours, UE 2, UE 3 and UE 4 are not loaded with many users. Based on this aforementioned scenario, the source NG-RAN node (204) determines that the UE 2, UE 3 and UE 4 can be switched off based on the measurement information 1 for half an hour after 12 hours. At step one, the source NG-RAN node (204) shares a Xn handover request to target NG-RAN node (206) including the use case 2 and the measurement information 1. Based on the measurement information 1, the target NG-RAN node (206) determines that for half an hour after 12 hours UE 7, UE 8 and UE 9 are also not loaded with many users and determines a measurement information 2 based on the use case 2 of switching of the UE 7, UE 8 and UE 9 for half an hour after 12 hours for network energy saving. At step two, the target NG-RAN node (206) shares a Xn handover response including the use case 2 and the associated measurement information 2. Based on the use case 2 and the associated measurement information 2, at step three, the source NG-RAN node (204) configures a measurement information 3 by checking if the measurement information 1 has to be de-configured or configured based on the measurement information 2. At step four, the source NG-RAN node (204) transmits the measurement information 3 to the UE (202) for configuring itself with the measurement information 3 related to switching of the UE 7, UE 8 and UE 9 along with UE 2, UE 3 and UE 4 for half an hour after 12 hours for network energy saving according to the load management use case. At step five, based on the measurement information 3, the UE (202) generates a measurement report and sends it to the target NG-RAN node (206).

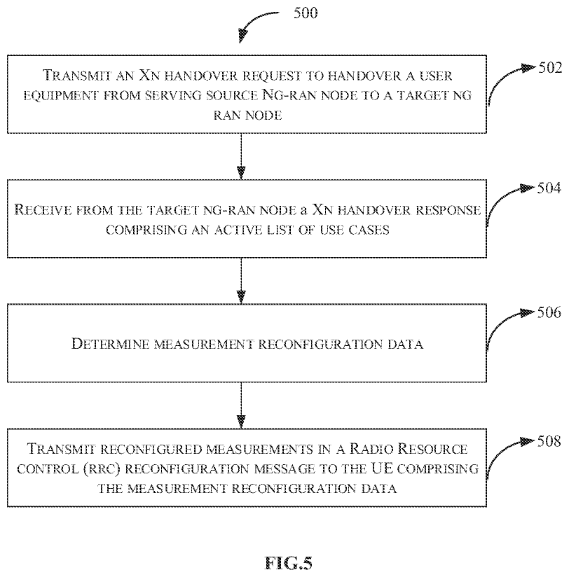

FIG. 5 shows a flowchart illustrating a method for a source NG-RAN node (204), in accordance with some embodiments of the present disclosure.

As illustrated in FIG. 5, the method (500) may include one or more blocks illustrating a method for managing interoperability of NG-RAN nodes in UE (202) handover, in accordance with some embodiments of the present disclosure illustrated in FIG. 5. The method (500) may be described in the general context of computer executable instructions. Generally, computer executable instructions can include routines, programs, objects, components, data structures, procedures, modules, and functions, which perform specific functions or implement specific abstract data types.

The order in which the method (500) is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 502, the method (500) includes transmitting, by a source NG-RAN node (204), an Xn handover request to handover a UE (202) from the source NG-RAN node (204) over an inter NG-RAN node interface to a target NG-RAN node (206). The Xn handover request comprises a list of Artificial Intelligence or Machine Learning (AI/ML) use cases configured at the source NG-RAN node (204) for the UE (202) and a corresponding first measurement information associated with the list of AI/ML use cases.

At block 504, the method (500) includes receiving, by the source NG-RAN node (204), from the target NG-RAN node (206), a Xn handover response comprising an active list of AI/ML use cases to be configured for the UE (202) at the target NG-RAN node (206) and a corresponding second measurement information associated with the active list of AI/ML use cases, based on the list of AI/ML use cases transmitted to the target NG-RAN node (206) from the source NG-RAN node (204).

At block 506, the method (500) includes determining, by the source NG-RAN node (204) measurement reconfiguration data (319) for the UE (202) based on the active list of AI/ML use cases received from the target NG-RAN node (206), until the UE (202) is handed over to the target NG-RAN node (206). The active list of AI/ML use cases comprises at least one of the one or more AI/ML use cases selected by the target NG-RAN node (206) from the list of AI/ML use cases provided by the source NG-RAN node (204) to the target NG-RAN node (206) for the UE (202) and one or more additional AI/ML use cases needed by the target NG-RAN node (206). In some embodiments, the measurement reconfiguration data (319) may include at least one of, but not limited to, the set of AI/ML use cases to be de-configured by identifying the AI/ML use cases other than the one or more AI/ML use cases selected by the target NG-RAN node (206) from the list of AI/ML use cases received at the source NG-RAN node (204) to the target NG-RAN node (206). Furthermore, the measurement reconfiguration data (319) comprises the set of additional AI/ML use cases to be configured are determined based on the one or more additional AI/ML use cases desired by the target NG-RAN node (206).

At block 508, the method (500) includes transmitting, by the source NG-RAN node (204), a Radio Resource Control (RRC) reconfiguration message, comprising the measurement reconfiguration data (319), to the UE (202), for dynamically updating measurements according to the list of AI/ML use cases supported by the target NG-RAN node (206) for the UE (202), based on the measurement reconfiguration data (319).

Claimable aspects:
1. In an embodiment, managing interoperability of NG-RAN nodes in UE handover is disclosed. The source NG-RAN node is configured to transmit over an inter NG-RAN node interface to a target NG-RAN node, an Xn handover request to handover a User Equipment (UE) from the source NG-RAN node to the target NG-RAN node. The Xn handover request comprises a list of Artificial Intelligence or Machine Learning (AI/ML) use cases configured at the source NG-RAN node for the UE and a corresponding first measurement information associated with the list of AI/ML use cases. In response to the Xn handover request, the source NG-RAN node receives from the target NG-RAN node, a Xn handover response comprising an active list of AI/ML use cases to be configured for the UE at the target NG-RAN node and a corresponding second measurement information associated with the active list of AI/ML use cases, based on the list of AI/ML use cases transmitted to the target NG-RAN node from the source NG-RAN node. Furthermore, the source NG-RAN node determines measurement reconfiguration data for the UE, based on the active list of AI/ML use cases received from the target NG-RAN node, until the UE is handed over to the target NG-RAN node. Thereafter, the source NG-RAN node transmits in a Radio Resource Control (RRC) reconfiguration message, the measurements reconfiguration data, to the UE, for dynamically updating measurements according to the list of AI/ML use cases supported by the target NG-RAN node for the UE, based on the measurement reconfiguration data.
2. In an embodiment, the source NG-RAN node as described in preceding aspect 1, wherein the active list of AI/ML use cases comprises at least one of the one or more AI/ML use cases selected by the target NG-RAN node from the list of AI/ML use cases provided by the source NG-RAN node to the target NG-RAN node for the UE and one or more additional AI/ML use cases needed by the target NG-RAN node.
3. In an embodiment, the source NG-RAN node as described in preceding aspect 1 to 2, wherein the measurement reconfiguration data comprises a set of measurements for AI/ML use cases to be de-configured from the list of AI/ML use cases configured at the source NG-RAN node, and a set of additional measurements for the new AI/ML use cases to be configured at the target NG-RAN node for the UE.
4. In an embodiment, the source NG-RAN node as described in preceding aspect 1 to 3, wherein the processor determines the measurements for the set of AI/ML use cases to be de-configured by identifying the AI/ML use cases other than the one or more AI/ML use cases selected by the target NG-RAN node from the list of AI/ML use cases configured at the source NG RAN node.
5. In an embodiment, the source NG-RAN node as described in preceding aspect 1 to 4, wherein the first measurement information comprises measurement parameters of the UE associated with the list of AI/ML use cases configured at the source NG-RAN node.
6. In an embodiment, the source NG-RAN node as described in preceding aspect 1 to 5, wherein the second measurement information comprises measurement parameters of the UE associated with the active list of AI/ML use cases received from the target NG-RAN node.
7. In an embodiment, the source NG-RAN node as described in preceding aspect 1 to 6, wherein prior to the handover the processor is further configured to receive a Xn setup request from the target NG-RAN node, wherein the Xn setup request comprises information indicating a list of AI/ML use cases supported by the target NG-RAN node, and interoperability information of AI/ML models of the AI/ML use cases supported by the target NG-RAN node. Thereafter, the processor is configured to transmit a Xn setup response to the target NG-RAN node, wherein the Xn setup response comprises information indicating a list of AI/ML use cases supported by the source NG-RAN node, and interoperability information of AI/ML models of the AI/ML use cases supported by the source NG-RAN node.
8. In an embodiment, a method for a source Next Generation-Radio Access Network (NG-RAN) node. The method comprises transmitting, by the source NG-RAN node, an Xn handover request to handover a User Equipment (UE) from the source NG-RAN node to a target NG-RAN node. The Xn handover request comprises a list of Artificial Intelligence or Machine Learning (AI/ML) use cases configured at the source NG-RAN node for the UE and a corresponding first measurement information associated with the list of AI/ML use cases. In response to the Xn handover request, the method comprises receiving, by the source NG-RAN node from the target NG-RAN node, a Xn handover response comprising an active list of AI/ML use cases to be configured for the UE at the target NG-RAN node and a corresponding second measurement information associated with the active list of AI/ML use cases, based on the list of AI/ML use cases transmitted to the target NG-RAN node from the source NG-RAN node. Further, the method comprises determining, by the source NG-RAN node, measurement reconfiguration data for the UE based on the active list of AI/ML use cases received from the target NG-RAN node, until the UE is handed over to the target NG-RAN node. Thereafter, the method comprises transmitting, by the source NG-RAN node, a Radio Resource Control (RRC) reconfiguration message, comprising the measurement reconfiguration data, to the UE, for dynamically updating measurements according to the list of AI/ML use cases supported by the target NG-RAN node for the UE, based on the measurement reconfiguration data.
9. In an embodiment, the method described in preceding aspect 8, wherein the active list of AI/ML use cases comprises at least one of the one or more AI/ML use cases selected by the target NG-RAN node from the list of AI/ML use cases provided by the source NG-RAN node to the target NG-RAN node for the UE and one or more additional AI/ML use cases needed by the target NG-RAN node.
10. In an embodiment, the method described in preceding aspect 8 to 9, wherein the measurement reconfiguration data comprises at least one of a set of measurements for AI/ML use cases to be de-configured from the list of AI/ML use cases configured at the source NG-RAN node, and a set of additional measurements for the new AI/ML use cases to be configured at the target NG-RAN node for the UE.
11. In an embodiment, the method described in preceding aspect 8 to 10, wherein the set of AI/ML use cases to be de-configured are determined by identifying the AI/ML use cases other than the one or more AI/ML use cases selected by the target NG-RAN node from the list of AI/ML use cases configured at the source NG RAN node.
12. In an embodiment, the method described in preceding aspect 8 to 11, wherein first measurement information comprises measurement parameters of the UE associated with the list of AI/ML use cases configured at the source NG-RAN node.
13. In an embodiment, the method described in preceding aspect 8 to 12, wherein second measurement information comprises measurement parameters of the UE (202) associated with the active list of AI/ML use cases received from the target NG-RAN node (206).
14. In an embodiment, method described in preceding aspect 8 to 13, further comprises prior to the handover of the UE, receiving a Xn setup request from the target NG-RAN node. The Xn setup request comprises information indicating a list of AI/ML use cases supported by the target NG-RAN node, and interoperability information of AI/ML models of the AI/ML use cases supported by the target NG-RAN node. Thereafter, the method comprises transmitting a Xn setup response to the target NG-RAN node, wherein the Xn setup response comprises information indicating a list of AI/ML use cases supported by the source NG-RAN node, and interoperability information of AI/ML models of the AI/ML use cases supported by the source NG-RAN node.
15. In yet another embodiment, a non-transitory computer readable medium including instructions stored thereon that when processed by at least one processor, cause a source NG-RAN node to perform operations comprising transmitting over an inter NG-RAN node interface to a target NG-RAN node to a target NG-RAN node, by source NG-RAN node an Xn handover request to handover a User Equipment (UE) from the source NG-RAN node to the target NG-RAN node. The Xn handover request The Xn handover request comprises a list of Artificial Intelligence or Machine Learning (AI/ML) use cases configured at the source NG-RAN node for the UE and a corresponding first measurement information associated with the list of AI/ML use cases. Furthermore, the instructions cause the source NG-RAN node to perform the operations comprising receiving from the target NG-RAN node, a Xn handover response comprising an active list of AI/ML use cases to be configured for the UE at the target NG-RAN node and a corresponding second measurement information associated with the active list of AI/ML use cases, based on the list of AI/ML use cases received by the target NG-RAN node from the source NG-RAN node in response to the Xn handover request. Furthermore, the instructions cause the source NG-RAN node to perform the operations comprising determining reconfiguration measurement data for the UE, based on the active list of AI/ML use cases received from the target NG-RAN node, until the UE is handed over to the target NG-RAN node. Thereafter, the instructions cause the source NG-RAN node to perform the operations comprising transmitting in a Radio Resource Control (RRC) reconfiguration message, the measurement reconfiguration data, to the UE, for dynamically updating measurements according to the list of AI/ML use cases supported by the target NG-RAN node for the UE, based on the measurement reconfiguration data.

Advantages of the embodiments of the present disclosure are illustrated herein.

In an embodiment, the proposed method enables managing interoperability of NG-RAN nodes in UE handover such that,
(1) It reduces unnecessary overhead for the NG-RAN nodes by eliminating reception of measurements from the UE which may be irrelevant to the AI/ML use cases supported by the NG-RAN nodes, and
(2) It reduces unnecessary overhead for the UE to measure and transmit huge amounts of data over the network, which may not be relevant to the NG-RAN node receiving the measurement. This also adds to the network overheads as transmission of such large amount of data needs to be managed.

Unlike the traditional techniques that causes a lot of unnecessary overhead due to vast amounts of data sent over the air interface because of partial interoperability or non-interoperability between the NG-RAN nodes, the present disclosure based on the list of AI/ML use cases, and the associated measurement information for each NG-RAN node, the UE may be provided with measurement reconfiguration data based on which the UE de-configures one or more existing AI/ML uses of the UE and configures new AI/ML use cases and the associated measurements. Therefore, the present disclosure provides flexibility to dynamically configure the UE as per the requirements of the AI/ML use cases of the target NG-RAN node during a handover. Additionally, by dynamically configuring the UE, the present disclosure eliminates issues related to partial interoperability or non-interoperability between the NG-RAN nodes.

As stated above, it shall be noted that the method of the present disclosure may be used to overcome various technical problems related to a managing interoperability of NG-RAN nodes in UE handover by a source NG-RAN node. In other words, the disclosed method has a practical application and provides a technically advanced solution to the technical problems associated with the existing approach of a managing interoperability of NG-RAN nodes in UE handover by a source NG-RAN node. In some embodiments, the present disclosure may also be applicable to a single NG-RAN node for mobility features such as L1/L2 triggered mobility and may be applicable over F1 and E1 interfaces. In some embodiments, the present disclosure may also be applicable for Load Traffic Manager (LTM), Directory Access Protocol (DAP) and the like.

In light of the technical advancements provided by the disclosed method, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present disclosure are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 202, 401 | User Equipment |
| 204, 402 | Source NG-RAN node |
| 206, 403 | Target NG-RAN node |
| 302 | Processor |
| 303 | Memory |
| 304 | I/O interface |
| 305 | Data |
| 307 | One or more modules |
| 309 | Xn handover request data |
| 311 | Xn handover response data |
| 313 | Measurement information data |
| 315 | AI/ML use case data |
| 317 | Active list data |
| 319 | Measurement reconfiguration data |
| 321 | Other data |
| 323 | Transceiver module |
| 325 | Determining module |
| 327 | Other modules |

We claim:

1. A system comprising:
a source Next Generation-Radio Access Network (NG-RAN) node (204) configured to:
transmit over an inter NG-RAN node interface to a target NG-RAN node (206), an Xn handover request to handover a User Equipment (UE) (202) from the source NG-RAN node (204) to the target NG-RAN node (206), wherein the Xn handover request comprises a list of Artificial Intelligence or Machine Learning (AI/ML) use cases configured at the source NG-RAN node (204) for the UE (202) and a corresponding first measurement information associated with the list of AI/ML use cases;
in response to the Xn handover request, receive from the target NG-RAN node (206), a Xn handover response comprising an active list of AI/ML use cases to be configured for the UE (202) at the target NG-RAN node (206) and a corresponding second measurement information associated with the active list of AI/ML use cases, based on the list of AI/ML use cases received by the target NG-RAN node (206) from the source NG-RAN node (204);
determine measurement reconfiguration data (319) for the UE (202), based on the active list of AI/ML use cases received from the target NG-RAN node (206), until the UE (202) is handed over to the target NG-RAN node (206); and
transmit in a Radio Resource Control (RRC) reconfiguration message, the measurement reconfiguration data (319), to the UE (202), for dynamically updating measurements according to the list of AI/ML use cases supported by the target NG-RAN node (206) for the UE (202), based on the measurement reconfiguration data (319).

2. The serving NG-RAN node of claim 1, wherein the active list of AI/ML use cases comprises at least one of the one or more AI/ML use cases selected by the target NG-RAN node (206) from the list of AI/ML use cases provided by the source NG-RAN node (204) to the target NG-RAN node (206) for the UE (202) and one or more additional AI/ML use cases needed by the target NG-RAN node (206).

3. The source NG-RAN node (204) of claim 1, wherein the measurement reconfiguration data (319) comprises at least one of
a set of measurements for AI/ML use cases to be de-configured from the list of AI/ML use cases configured at the source NG-RAN node (204), and
a set of additional measurements for the new AI/ML use cases to be configured at the target NG-RAN node (206) for the UE (202).

4. The source NG-RAN node (204) of claim 3, further configured to determine the measurements for the set of AI/ML use cases to be de-configured by identifying the AI/ML use cases other than the one or more AI/ML use cases selected by the target NG-RAN node (206) from the list of AI/ML use cases configured at the source NG RAN node.

5. The source NG-RAN node (204) of claim 1, wherein the first measurement information comprises measurement parameters of the UE (202) associated with the list of AI/ML use cases configured at the source NG-RAN node (204).

6. The source NG-RAN node (204) of claim 1, wherein the second measurement information comprises measurement parameters of the UE (202) associated with the active list of AI/ML use cases received from the target NG-RAN node (206).

7. The source NG-RAN node (204) of claim 1, further configured to:
prior to the handover of the UE (202), receive a Xn setup request from the target NG-RAN node (206), wherein the Xn setup request comprises information indicating a list of AI/ML use cases supported by the target NG-RAN node (206), and interoperability information of AI/ML models of the AI/ML use cases supported by the target NG-RAN node (206); and
transmit a Xn setup response to the target NG-RAN node (206), wherein the Xn setup response comprises information indicating a list of AI/ML use cases supported by the source NG-RAN node (204), and interoperability information of AI/ML models of the AI/ML use cases supported by the source NG-RAN node (204).

8. A method comprising:
transmitting, by the source NG-RAN node (204), an Xn handover request to handover a User Equipment (UE) (202) from the source NG-RAN node (204) over an inter NG-RAN node interface to a target NG-RAN node (206), wherein the Xn handover request comprises a list of Artificial Intelligence or Machine Learning (AI/ML) use cases configured at the source NG-RAN node (204) for the UE (202) and a corresponding first measurement information associated with the list of AI/ML use cases;
in response to the Xn handover request, receiving, by the source NG-RAN node (204), from the target NG-RAN node (206), a Xn handover response comprising an active list of AI/ML use cases to be configured for the UE (202) at the target NG-RAN node (206) and a corresponding second measurement information associated with the active list of AI/ML use cases, based on the list of AI/ML use cases transmitted to the target NG-RAN node (206) from the source NG-RAN node (204);
determining, by the source NG-RAN node (204), measurement reconfiguration data (319) for the UE (202) based on the active list of AI/ML use cases received from the target NG-RAN node (206), until the UE (202) is handed over to the target NG-RAN node (206); and
transmitting, by the source NG-RAN node (204), a Radio Resource Control (RRC) reconfiguration message, comprising the measurement reconfiguration data (319), to the UE (202), for dynamically updating measurements according to the list of AI/ML use cases supported by the target NG-RAN node (206) for the UE (202), based on the measurement reconfiguration data (319).

9. The method of claim 8, wherein the active list of AI/ML use cases comprises at least one of the one or more AI/ML use cases selected by the target NG-RAN node (206) from the list of AI/ML use cases provided by the source NG-RAN node (204) to the target NG-RAN node (206) for the UE (202) and one or more additional AI/ML use cases needed by the target NG-RAN node (206).

10. The method of claim 8, wherein the measurement reconfiguration data (319) comprises at least one of
a set of measurements for AI/ML use cases to be de-configured from the list of AI/ML use cases configured at the source NG-RAN node (204), and
a set of additional measurements for the new AI/ML use cases to be configured at the target NG-RAN node (206) for the UE (202).

11. The method of claim 10, wherein the set of AI/ML use cases to be de-configured are determined by identifying the AI/ML use cases other than the one or more AI/ML use cases selected by the target NG-RAN node (206) from the list of AI/ML use cases configured at the source NG RAN node (204).

12. The method of claim 8, wherein the first measurement information comprises measurement parameters of the UE (202) associated with the list of AI/ML use cases configured at the source NG-RAN node (204).

13. The method of claim 8, wherein the second measurement information comprises measurement parameters of the UE (202) associated with the active list of AI/ML use cases received from the target NG-RAN node (206).

14. The method of claim 8, further comprises:
prior to the handover of the UE (202), receiving a Xn setup request from the target NG-RAN node (206), wherein the Xn setup request comprises information indicating a list of AI/ML use cases supported by the target NG-RAN node (206), and interoperability information of AI/ML models of the AI/ML use cases supported by the target NG-RAN node (206); and
transmitting a Xn setup response to the target NG-RAN node (206), wherein the Xn setup response comprises information indicating a list of AI/ML use cases supported by the source NG-RAN node (204), and interoperability information of AI/ML models of the AI/ML use cases supported by the source NG-RAN node (204).

15. A non-transitory computer readable medium including stored thereon that when processed by at least one processor (302), cause a source NG RAN node to perform operations comprising:
transmitting over an inter NG-RAN node interface to a target NG-RAN node (206), by source NG-RAN node (204) an Xn handover request to handover a User Equipment (UE) (202) from the source NG-RAN node (204) to the target NG-RAN node (206), wherein the Xn handover request comprises a list of Artificial Intelligence or Machine Learning (AI/ML) use cases configured at the source NG-RAN node (204) for the UE (202) and a corresponding first measurement information associated with the list of AI/ML use cases;
in response to the Xn handover request, receiving from the target NG-RAN node (206), by the source NG-RAN node (204), a Xn handover response comprising an active list of AI/ML use cases to be configured for the UE (202) at the target NG-RAN node (206) and a corresponding second measurement information associated with the active list of AI/ML use cases, based on the list of AI/ML use cases received by the target NG-RAN node (206) from the source NG-RAN node (204);
determining, by the source NG-RAN node (204), reconfiguration measurement data for the UE (202), based on the active list of AI/ML use cases received from the target NG-RAN node (206), until the UE (202) is handed over to the target NG-RAN node (206); and
transmitting, by the source NG-RAN node (204), in a Radio Resource Control (RRC) reconfiguration message, the measurement reconfiguration data (319), to the UE (202), for dynamically updating measurements according to the list of AI/ML use cases supported by the target NG-RAN node (206) for the UE (202), based on the measurement reconfiguration data (319).
